(19) United States
(12) Patent Application Publication
(10) Pub. No.: US 2022/0099473 A1
(43) Pub. Date: Mar. 31, 2022

(54) DEVICE FOR THE MEASUREMENT OF THE FLOW RATE OF A GAS IN A GAS PIPING

(71) Applicant: PIETRO FIORENTINI S.P.A., Arcugnano (VI) (IT)

(72) Inventor: Claudio Imboccioli, Creazzo (IT)

(21) Appl. No.: 17/426,785

(22) PCT Filed: Feb. 28, 2020
(86) PCT No.: PCT/IB2020/051720

§ 371 Date: Jul. 29, 2021

(30) Foreign Application Priority Data
Mar. 1, 2019 (IT) 102019000002969

(51) Int. Cl. G01F 15/18; G01F 1/667; G01F 5/00

(52) U.S. Cl. CPC G01F 15/185; G01F 5/00; G01F 1/667

(57) ABSTRACT

A device for the measurement of a flow rate of a gas in a main gas piping includes: a first branch configured for the diversion of a portion of a gas flow in transit in the main piping towards a measuring component; the measuring component including an inlet mouth, connected to the first branch, and an outlet mouth, the measuring component being configured for the direct measurement of the flow rate of the portion of gas flow, diverted by the main piping, which crosses the same measuring component; and a second branch connected to the outlet mouth and configured for the re-introduction into the main piping of the diverted portion of gas flow crossing the measuring component.

### BACKGROUND OF THE INVENTION

### 1. The Field of the Invention

The invention relates to a device for the measurement of the flow rate of a gas in a gas piping.

### 2. The Relevant Technology

Nowadays, for measuring the flow rate of a gas inside a pipe, it is possible to choose between a multiplicity of measuring devices, for example of the membrane deformation type, or of the turbine type, or of the hot wire type, ultrasonic systems, and other similar and equivalent ones.

These devices and systems are normally used at points where a precise measurement is required for tax reasons.

Due to the continuous expansion and diffusion of the so-called ‘smart grids’ at the infrastructural level also in the gas distribution field, where ‘smart gas grid’ means a smart gas distribution network that is provided with digital communication systems, smart measurement, control and monitoring, the request for introducing, on already existing and unmonitored sections of distribution lines of networks, devices and systems for the measurement of the gas flow rate where these devices were originally not planned, in order to control, modulate and optimize gas distribution, balance the network and distribute loads evenly to nodes and utilities, is growing steadily.

As mentioned above, systems and devices for detecting the flow rate of a gas configured for the installation at final utilities, where an adequate space can be easily obtained, are currently known and widespread.

The introduction of such known systems and devices on already existing pipings entails numerous drawbacks, linked to the fact that in order to implement this introduction it is necessary to obtain space on such pipings, with technical interventions for removing and replacing a segment or a portion of a segment, with consequent temporary interruption of the service on that line or, alternatively, with the installation of a by-pass.

### SUMMARY OF THE DISCLOSURE

The task of the present invention is to provide a device for the measurement of the flow rate of a gas in a piping that can be installed without interrupting the supply service.

Another object of the invention is to develop a device for the measurement of the flow rate of a gas that can be installed without requiring the partial or total removal of the segment where it is applied.

The above mentioned task and objects are achieved by a device for the measurement of the flow rate of a gas in a gas piping.

Further characteristics of the device for the measurement of the flow rate of a gas are described in the claims.

### BRIEF DESCRIPTION OF THE DRAWINGS

The task and the aforesaid objects, together with the advantages which will be mentioned below, are highlighted by the description of four embodiments of the device according to the invention, which is given, by way of non-limiting example, with reference to the accompanying drawings, where:

FIG. 1 is a partially sectional schematic side view of a device for the measurement of the flow rate of a gas according to the invention in a first embodiment thereof;

FIG. 2 is a partially sectional schematic side view of a device for the measurement of the flow rate of a gas according to the invention in a second embodiment thereof;

FIG. 3 is a partially sectional schematic side view of a device for the measurement of the flow rate of a gas according to the invention in a third embodiment thereof;

FIG. 4 is a partially sectional schematic side view of a device for the measurement of the flow rate of a gas according to the invention in a fourth embodiment thereof.

### DETAILED DESCRIPTION OF THE PREFERRED EMBODIMENTS

A method for detecting the flow rate Q of a gas in a main piping 11, comprises the following steps:
diverting a portion of a gas flow in transit in a main piping 11 from said main piping 11 towards measuring means 13,
directly measuring the flow rate q of the diverted portion of gas flow,
re-introducing the portion of gas flow whose flow rate q was measured in said main piping 11,
calculating the flow rate Q of the gas flow in the main piping 11 as a function of the flow rate q of the diverted portion of gas flow.

The flow rate q of the measured portion of gas flow is correlated, through an algorithm, to the total flow rate Q of the gas flow of the main piping 11, whose identification is the main purpose of the invention itself.

In particular, the number of sampling holes is related to the diameter of the main piping 11 according to a mathematical relationship described below.

This mathematical relationship provides for the unknown flow rate Q of the gas flow in the main piping 11 to be a function of the flow rate q of the diverted portion of gas flow measured by the measuring means 13 located on the by-pass line according to the formula:

Q=K·q

where the following formulas apply to the calibration coefficient K:

$$K = f ( \{ {Q}_{ref , i} , {k}_{i} \} , q )$$

$${k}_{i} = f ( ϕ , S , P , T , ϱ , d , f , n ) = \frac{{Q}_{ref , i}}{q\_cal ( ϕ , S , P , T , ϱ , d , f , n )}$$

The calibration coefficient K is therefore a function, in turn:
of a set of n calibration measurements {Q_{ref,i}, kᵢ}, with ‘i’ equal to a number between 1 and n, wherein through the relationship between a pre-established flow rate of reference Q_{ref,i} and a corresponding flow rate q_calᵢ measured with the measuring means 13, the calibration coefficient kᵢ at flow rate Q_{ref,i} is determined,
of the flow rate qᵢ measured by the measuring means 13,
of the diameter ϕ of the main piping 11,
of the section of the branch pipes 12 and 16, and the relative section of the lateral sampling holes 21, 22 and 23 and of the lateral return holes 32, 33 and 34, and of their number, if any,
of the pressure in the piping, P
of the temperature in the piping, T
of the density of the gas ρ,
   where the wording f( . . . ) means “function of” and “q_cal” is the flow rate measured by the measuring means 13 during the calibration procedure.

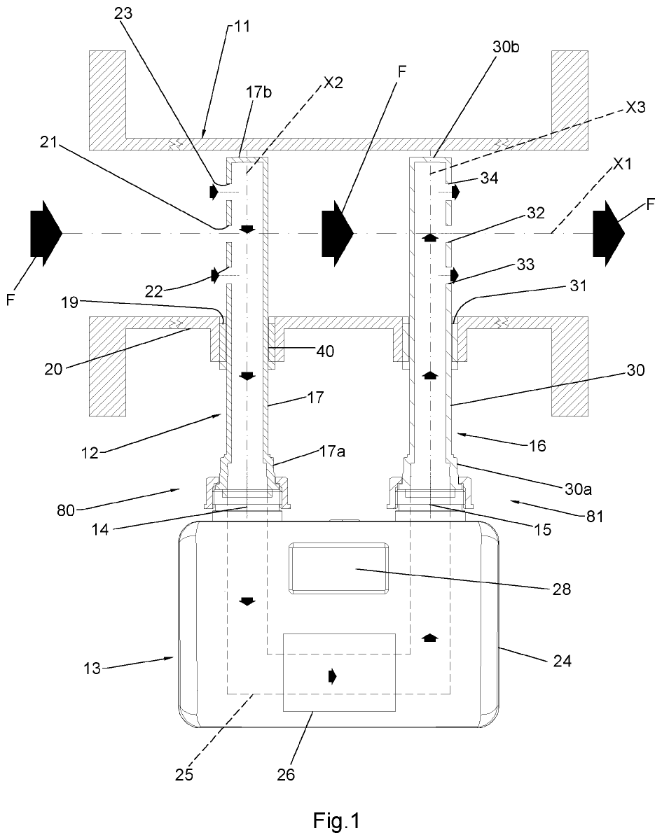

With reference to FIG. 1, a device for the measurement of the flow rate of a gas in a gas piping according to the invention is indicated as a whole of the first embodiment thereof with number 10.

Said device 10 for the measurement of the flow rate of a gas in a main gas piping 11 comprises:
first branch means 80 configured for the diversion of a portion of a gas flow in transit in a main piping 11 towards measuring means 13,
measuring means 13, comprising an inlet mouth 14, connected to the first branch means 80, and an outlet mouth 15, said measuring means 13 being configured for the direct measurement of the flow rate of the portion of gas flow, diverted by the main piping 11, which crosses the same measuring means 13,
second branch means 81, connected to the outlet mouth 15 and configured for the re-introduction into the main piping 11 of the diverted portion of gas flow crossing the measuring means 13.

In the first embodiment of the invention the first branch means 80 comprise a first branch pipe 12, configured to be positioned inside the main piping 11 according to a second direction X2 at least in part transversal to a first transit direction X1 of a gas in the main piping 11; the first branch pipe 12 is configured for the diversion of a portion of a gas flow in transit in the main piping 11 towards the measuring means 13, better described below.

The second branch means 81 comprise a second branch pipe 16, connected to the outlet mouth 15 and configured for the re-introduction into said main piping 11 of the portion of gas flow crossing the measuring means 13.

In the first embodiment of the invention, obviously described by way of non-limiting example of the invention itself, the first branch pipe 12 comprises a sampling tube 17.

Said sampling tube 17 is configured so as to develop according to a second direction X2 orthogonal to the first direction X1.

This second direction X2 is to be intended as being able to deviate from the orthogonality with the first direction X1.

Said sampling tube 17 crosses the wall 20 of the main piping 11 at a through hole 19, for example radial with respect to the first direction X1, defined on the same wall 20.

Said sampling tube 17 has at a first end 17a a connecting section for the connection with the measuring means 13, and in particular with the inlet mouth 14 of the measuring means 13.

The sampling tube 17 has a second end 17b, opposite to the first end 17a, closed, i.e., obstructed.

Preferably, but not necessarily, the sampling tube 17 is positioned in such a way that the second end 17b is close to or in contact with the internal surface of the wall 20.

The sampling tube 17 has at least one lateral sampling hole 21.

The term ‘hole’ means a through opening of any shape, i.e., circular shape, or polygonal shape, or elliptical, or oval shape, or with an outline of another shape depending on the needs and technical requirements.

In this first embodiment, each lateral sampling hole is defined according to a direction parallel to the first direction X1 of the main piping 11.

Obviously, the holes are to be intended as being able to have a different direction from the direction X1 of the main piping 11, and such as to allow the holes themselves to perform the same functionality.

In particular, in the present embodiment, the sampling tube 17 has three lateral sampling holes 21, 22 and 23 respectively.

The term ‘lateral’ attributed to the sampling holes means that they are defined on the longitudinal wall of the sampling tube 17.

These lateral sampling holes 21, 22 and 23 are open and turned in the direction opposite to the direction of the gas flow in the main piping 11, where this direction of the gas flow is indicated by the arrow F; in this way they intercept optimally the gas flow in transit in the main piping 11.

It should be noted that the letter “F” also refers to the same gas flow.

In the present embodiment of the invention, a lateral sampling hole 21 is positioned at the main axis of symmetry of the main piping 11.

Obviously, also variants in which none of the lateral sampling holes are positioned at the main axis of symmetry of the main piping 11 are to be intended as part of the invention.

Preferably, the lateral sampling holes 21, 22 and 23 are positioned in the central area of the main piping 11, since it is the area where the gas flow is less disturbed by the various perturbations that can afflict a gas flow in a piping, such as example the ‘wall effects’.

The sampling tube 17 crosses the through hole 19 by interposition of sealing means 40.

Said sealing means can consist of corresponding gaskets, or O-rings, or sealing threads, or liquid gaskets, or sealing tapes, for example of Teflon, or other similar means, considered individually or in combination, depending on the needs and technical requirements.

The measuring means 13, configured for the direct measurement of the flow rate of the portion of gas flow diverted through the first branch pipe 12 by the main piping 11, comprise a box-like containment body 24, inside which a passage 25 is defined in which the portion of gas flow, intercepted and diverted by the first branch means 80, i.e., by the first branch pipe 12, passes from the inlet mouth 14 to the outlet mouth 15.

Inlet mouth 14 and outlet mouth 15 are defined on the box-like body 24.

The passage 25 is configured in such a way as to let the diverted portion of gas flow pass through a flow rate detector 26 configured for the direct measurement of the transiting gas flow.

The flow rate detector 26 is interposed between the inlet mouth 14 and the outlet mouth 15, inside the box-like body 24.

This flow rate detector 26 is, for example, of the ultrasound type.

Alternatively, this flow rate detector 26 is of the membrane type, or of the thermo-mass type, or of the rotoid type, or of the turbine type, or of the flow meter type, or of another similar and equivalent type, depending on the specific technical needs.

The measuring means 13 comprise an electronic unit 28 configured for the transmission of the flow rate values detected by the flow rate detector 26.

This electronic unit 28 is configured to calculate the gas flow rate in the main piping 11 starting from the values detected by measuring the flow rate of the portion of gas flow passing through the flow rate detector 26.

The measuring device 10 can comprise an electronic remote calculation unit, not illustrated for simplicity purposes, dedicated to carrying out this calculation of the gas flow rate in the main piping 11.

The electronic unit 28 can therefore be configured
either to receive the flow rate values of the gas flow portion detected by the flow rate detector 26 and transmit them to a remote calculation unit,
or to receive the flow rate values of the gas flow portion detected by the flow rate detector 26, calculate the gas flow rate in the main piping 11 and transmit the calculated values to a central control and management unit.

The electronic unit 28 can also be configured to calculate the volumes of gas flow transited in a time interval.

In the first embodiment described herein, the second branch pipe 16, connected to the outlet mouth 15 and configured for the re-introduction into the main piping 11 of the portion of gas flow crossing the measuring means 13, is equal to the first branch pipe 12 and positioned specularly with respect thereto, i.e., with the lateral holes turned in the same direction of the gas flow F.

It is obviously to be understood that this second branch pipe 16, despite the functional equivalence, can be different from the first branch pipe 12, i.e., of different length in its main development direction, with different number of lateral holes, with different position of the lateral holes with respect to the first branch pipe 12.

In particular, therefore, in the first embodiment of the invention shown in FIG. 1, obviously described by way of non-limiting example of the invention itself, the second branch pipe 16 comprises a return tube 30, configured to be positioned according to a third direction X3 orthogonal to the first direction X1.

This third direction X3 is to be intended as being able to deviate from the orthogonality with the first direction X1.

This return tube 30 crosses the wall 20 of the main piping 11 at a corresponding through hole 31, for example, and not exclusively, radial with respect to the first direction X1, defined on the same wall 20 of the main piping 11.

Said return tube 30 has, at a first end 30a, a connecting section for the connection with the measuring means 13, and in particular with the outlet mouth 15 of the measuring means 13.

The return tube 30 has a second end 30b, opposite to the first end 30a, closed, i.e., obstructed.

Preferably, but not necessarily, the return tube 30 is positioned in such a way that the second end 30b is close to or in contact with the internal surface of the wall 20.

The return tube 30 has at least one lateral return hole 32.

In the non-limiting example described, each lateral return hole is defined according to a direction parallel to the first direction X1 of the main piping 11.

In particular, in the present embodiment, the return tube 30 has three lateral return holes 32, 33 and 34 respectively.

The term ‘lateral’ attributed to the return holes means that they are defined on the longitudinal wall of the return tube 30.

These lateral return holes 32, 33 and 34 are open and turned in the same direction of the gas flow F in the main piping 11.

In particular, again by way of non-limiting example of the invention, each of the lateral return holes 32, 33 and 34 is defined in a radial position of alignment with a corresponding sampling hole 21, 22 and 23.

This mutual position of the sampling holes 21, 22 and 23 and of the return holes 32, 33 and 34 allows the re-introduction of the sampled portion of gas flow, diverted through the first branch pipe 12 into the measuring means 13, in the same areas of the gas flow in the main piping 11 from which it was taken, minimizing the interference of the measuring device 10 on the gas flow in transit in the same main piping 11.

Like the sampling tube 17, the return tube 30 also crosses the through hole 31 by interposition of sealing means 40, to be intended as described above.

In a variant embodiment, not illustrated for simplicity purposes, the return tube develops between the outlet mouth 15 and the through hole 19, without entering the internal tubular compartment of the main piping 11.

In this case, the return tube has no lateral holes.

In this case, the second end of the return tube is open, and through it the portion of gas flow returns from the measuring means 13 to the main piping 11.

This measuring device 10 according to the invention, thanks to the first branch means 80, i.e., to the first branch pipe 12, to the measuring means 13 and to the second branch means 81, i.e., to the second branch pipe 16, allows creating a pressure differential between two points of a main piping 11 (by sampling and discharging the gas in two separate points, or in the same point as described below), giving rise to a by-pass line inside which the flow rate of the drained portion of gas flow is directly detected.

The first branch means 80, i.e., the first branch pipe 12, the measuring means 13 and the second branch means 81 therefore give rise to a by-pass line.

In this way, a drainage of gas flow from the total flow rate transiting in the main piping 11 is made, i.e., a portion of gas flow well below the total flow rate transiting in the main piping 11.

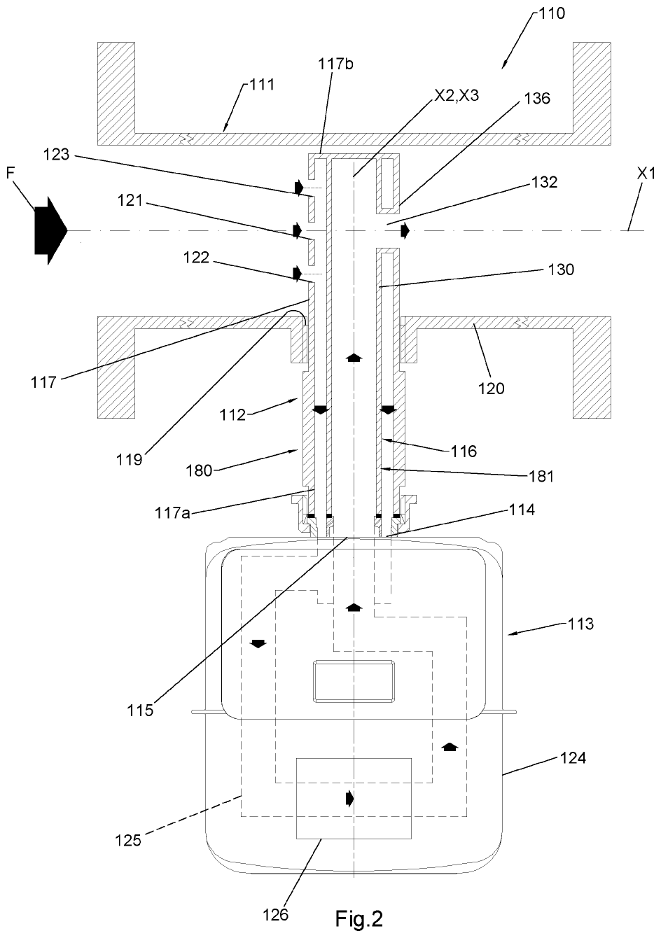

A device for the measurement of the flow rate of a gas in a gas piping according to the invention is represented in a second embodiment thereof in FIG. 2, and is indicated therein as a whole with number 110.

Said measuring device 110 comprises, similarly to the first embodiment:
first branch means 180, which in turn comprise a first branch pipe 112, developing inside a main piping 111 according to a second direction X2 at least in part transversal to the first direction X1 of the main piping 111;
the first branch pipe 112 is configured for the diversion of a portion of a gas flow in transit in the main piping 111 towards measuring means 113, better described below;
measuring means 113, comprising an inlet mouth 114, connected to the first branch pipe 112, and an outlet mouth 115; these measuring means 113 are configured for the direct measurement of the flow rate of the portion of gas flow, diverted by the main piping 111, which crosses the same measuring means 113;
and second branch means 181, which in turn comprise a second branch pipe 116, connected to the outlet mouth 115 and configured for the re-introduction into the main piping 111 of the diverted portion of gas flow crossing the measuring means 113.

In this second embodiment, the first branch pipe 112 at least partially surrounds the second branch pipe 116.

In particular, the first branch pipe 112 and the second branch pipe 116 are concentric.

As clearly visible in FIG. 2, the first branch pipe 112 is external with respect to the second branch pipe 116.

In particular, as clearly visible from FIG. 2, the first branch pipe 112 entirely surrounds the second branch pipe 116, i.e., over the whole development direction of the latter.

In this second embodiment, the main piping 111 has a single through hole 119, configured for the passage of the first branch pipe 112.

Similarly to what has been described above for the first embodiment of the measuring device 10 according to the invention, the first branch pipe 112 comprises an external sampling tube 117, developing according to a second direction X2 orthogonal to the first direction X1.

As visible in FIG. 2, the sampling tube 117 is a cylindrical tube.

This second direction X2 is to be intended as being able to deviate from the orthogonality with the first direction X1.

Said sampling tube 117 crosses the wall 120 of the main piping 111 at the through hole 119, for example radial with respect to the first direction X1, defined on the same wall 120.

Said sampling tube 117 has at a first end 117a a connecting section for the connection with the measuring means 113, and in particular with the inlet mouth 114 of the measuring means 113.

The sampling tube 117 has a second end 117b, opposite to the first end 117a, which second end 117b is closed, i.e., obstructed.

Preferably, but not necessarily, the sampling tube 117 is positioned in such a way that the second end 117b is close to or in contact with the internal surface of the wall 120.

The sampling tube 117 has at least one lateral sampling hole, for example three lateral sampling holes 121, 122 and 123, respectively.

The term ‘lateral’ attributed to the sampling holes means that they are defined on the longitudinal wall of the sampling tube 117.

These lateral sampling holes 121, 122 and 123 are open and turned in the direction opposite to the direction of the gas flow in the main piping 111, where this direction of the gas flow is indicated by the arrow F; in this way they intercept optimally the gas flow in transit in the main piping 111.

Preferably, as visible in FIG. 2, a lateral sampling hole 121 of the sampling tube 117 is placed at the axis of the main piping 111.

The same considerations expressed for the lateral sampling holes of the first embodiment of the invention described above apply to the lateral sampling holes 121, 122 and 123.

Obviously the lateral sampling holes are to be intended as being able to be at least three, i.e., even more than three.

In this second embodiment of the invention, the second branch pipe 116, connected to the outlet mouth 115 and configured for the re-introduction into the main piping 111 of the portion of gas flow crossing the measuring means 113, is positioned concentric with respect to the first branch pipe 112, and with a lateral return hole 132 turned in the same direction of the gas flow F.

As visible in FIG. 2, the lateral return hole 132 develops along the same axis as the main piping 111.

This peculiarity leads to the advantage of carrying out the re-introduction into the main piping 111 of the portion of gas flow that has crossed the measuring means 113, in an area of less disturbance for the flow of gas flowing in the main piping 111 downstream of the first branch pipe 112, less than in other possible re-introduction directions.

The second branch pipe 116 comprises a return tube 130, developing according to a third direction X3 orthogonal to the first direction X1; in this second embodiment of the invention, the third direction X3 coincides with the second direction X2.

As visible in FIG. 2, the return tube 130 is also a cylindrical tube.

The lateral return hole 132 comprises a tubular section 136 positioned between the return tube 130 and the sampling tube 117, so as to create a passage between the second branch pipe 116 and the inside of the main piping 111.

This return tube 130 crosses the wall 120 of the main piping 111 inside the sampling tube 117.

A transit cavity is defined between the sampling tube 117 and the return tube 130.

The portion of gas drained by the sampling tube 117 descends towards the inlet mouth 114 through the transit cavity.

The inlet mouth 114 and the outlet mouth 115 are also positioned concentrically in the measuring means 113.

The measuring means 113, configured for the direct measurement of the flow rate of the portion of gas flow diverted through the first branch pipe 112 by the main piping 111, comprise, as described above for the first embodiment of the invention, a box-like containment body 124, inside which a passage 125 is defined in which the portion of gas flow, intercepted and diverted by the first branch pipe 112, passes from the inlet mouth 114 to the outlet mouth 115.

Inlet mouth 114 and outlet mouth 115 are defined concentrically on the box-like body 124.

The passage 125 is configured in such a way as to let the portion of gas flow pass through a flow rate detector 126 configured for the direct measurement of the transiting gas flow.

The flow rate detector 126 is interposed between the inlet mouth 114 and the outlet mouth 115, inside the box-like body 124.

This second embodiment of the device for the measurement of the flow rate of a gas in a main piping 111 is particularly convenient in terms of simplicity of application, since the use thereof requires the construction of a single through hole 119 in the wall 120 of the main piping 111.

This second embodiment of the device for the measurement of the flow rate of a gas in a main piping 111 is even more particularly convenient in terms of simplicity of construction, since it comprises a first branch pipe 112 and a second branch pipe 116 which comprise respectively a sampling tube 117 and a return tube 130 which are cylindrical, therefore easy to manufacture, and positioned concentrically, with the end of the return tube 130 in contact with the second end 117b of the sampling tube 117, therefore easy to assemble.

The other parts and details are intended as corresponding to what described above for the first embodiment of the invention.

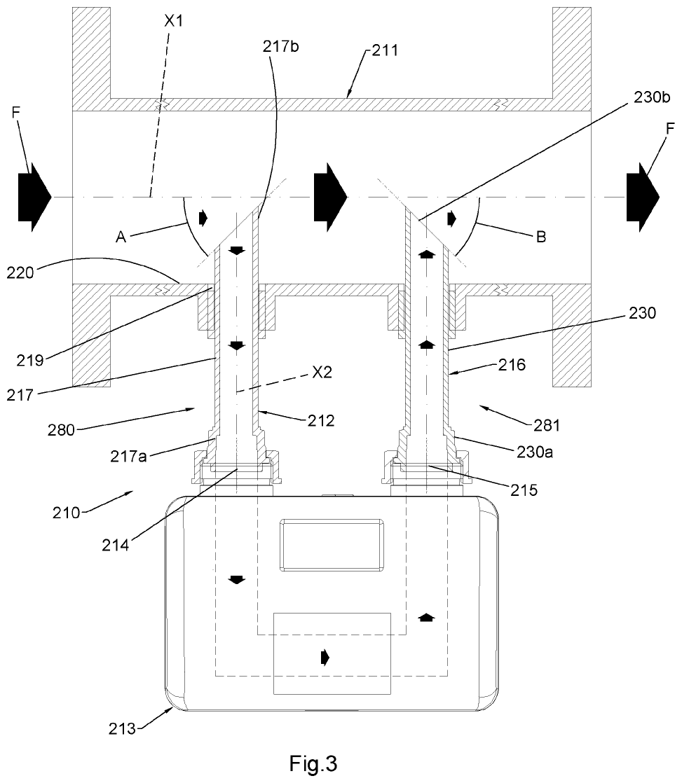

In a third embodiment of the invention, represented in FIG. 3, and indicated therein as a whole with number 210, the device for the measurement of the flow rate of a gas in a main gas piping 211 according to the invention comprises, similarly to what has been already described above:
first branch means 280 configured for the diversion of a portion of a gas flow in transit in a main piping 211 towards measuring means 213,
measuring means 213, comprising an inlet mouth 214, connected to the first branch means 280, and an outlet mouth 215, said measuring means 213 being configured for the direct measurement of the flow rate of the portion of gas flow, diverted by the main piping 211, which crosses the same measuring means 213,
second branch means 281, connected to the outlet mouth 215 and configured for the re-introduction into the main piping 211 of the diverted portion of gas flow crossing the measuring means 213.

In this third embodiment of the invention the first branch means 280 comprise a first branch pipe 212, developing inside the main piping 211 according to a second direction X2 at least in part transversal to a first transit direction X1 of a gas in the main piping 211; the first branch pipe 212, configured for the diversion of a portion of a gas flow in transit in the main piping 211 towards the measuring means 213, comprises a sampling tube 217 which crosses the wall 220 of the main piping 211 at a through hole 219.

Said sampling tube 217 has at a first end 217a a connecting section for the connection with the measuring means 213, and in particular with the inlet mouth 214 of the measuring means 213.

The sampling tube 217 has a second end 217b, opposite to the first end 217a, open and inclined by an interception angle A with respect to the transit direction X1 of the gas in the main piping 211.

This interception angle A is, for example, comprised between 20° and 80°, and preferably is 45°.

The opening of the second end 217b is obviously turned in such a way as to intercept the gas flow F.

By way of non-limiting example of the invention, the second branch means 281 comprise a second branch pipe 216, connected to the outlet mouth 215 and configured for the re-introduction into said main piping 211 of the portion of gas flow crossing the measuring means 213.

Said second branch pipe 216 comprises a return tube 230, which has at a first end 230a a connecting section for the connection with the measuring means 213, and in particular with the outlet mouth 215 of the measuring means 213.

The return tube 230 has a second end 230b, opposite to the first end 230a, open and inclined by an interception angle B with respect to the transit direction X1 of the gas in the main piping 211.

This interception angle B is, for example, comprised between 20° and 80°, and preferably is 45°.

The opening of the second end 230b is obviously turned in such a way as to re-introduce the diverted portion of gas flow into the main piping 211 in the same direction of transit of the gas flow F.

The positions of the second ends 217b and 230b inside the main piping 211 are to be intended as being able to be any according to the needs and technical requirements.

The branch means 280 and 281 of this third embodiment, the branch means 80 and 81 of the first embodiment and the branch means 180 and 181 of the second embodiment are to be intended as combinable so as to define other variant embodiments not illustrated for simplicity purposes, but also to be intended as the object of the invention.

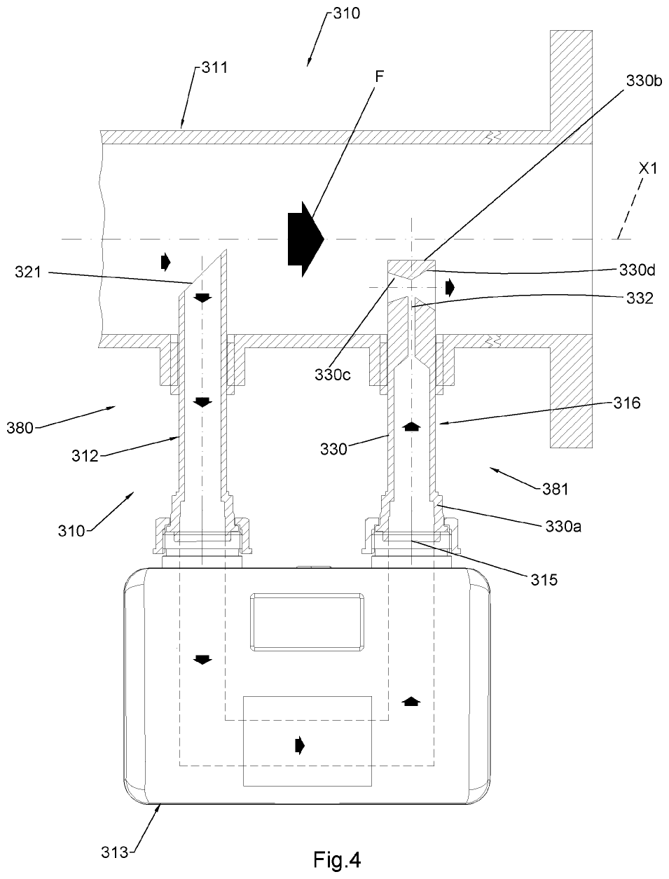

In a fourth embodiment of the measuring device according to the invention, represented in FIG. 4 and indicated therein as a whole with number 310, the second branch means 381 comprise a second branch pipe 316, connected to the outlet mouth 315 and configured for the re-introduction into the main piping 311 of the portion of gas flow crossing the measuring means 313.

Said second branch pipe 316 comprises a return tube 330, which has at a first end 330a a connecting section for the connection with the measuring means 313, and in particular with the outlet mouth 315 of the measuring means 313.

The return tube 330 has a second end 330b, opposite to the first end 330a, which second end 330b is configured to cause, at a return hole 332, a pressure P2 which is lower than the pressure P1 at a sampling hole 321 of the first branch pipe 312.

For example, and not limited to, the second end 330b is shaped like a Venturi tube.

This second end 330b therefore has a through hole, in the direction X1, having a convergent inlet section 330c and a divergent outlet section 330d, in the direction of transit of the gas flow F.

The first branch means 380 are to be intended as being able to be one of the types described above for the other embodiments of the invention.

It has in practice been established that the invention achieves the intended task and objects.

In particular, with the invention a device for the measurement of the flow rate of a gas that can be installed without interrupting the supply service has been developed by using the techniques known in the sector to make one or two through holes on a piping already in place without interrupting the supply service, so that the device according to the invention can be applied thereto.

Therefore, with the invention a device for the measurement of the flow rate of a gas that can be installed without removing in part or in whole a piping where it is supposed to be applied has been developed.

Furthermore, with the invention a device for the measurement of the flow rate of a gas has been developed in which the measuring means 13 and 113 can substantially also consist of a gas meter of a residential or commercial type known per se.

In addition, the device for the measurement of the flow rate of a gas according to the invention is configured for the measurement of a gas flow and not of a pressure differential.

The device for the measurement of the flow rate of a gas according to the invention allows creating a connected system, by sending data to a control centre of the network, widespread and with low monitoring costs, which today is not present at the final distribution level.

This also allows monitoring and managing the network, obtaining a reduction of gas emissions into the atmosphere due to the leakages, i.e., gas leaks, of the same networks.

This measuring device according to the invention ensures a guaranteed measurement without the need for electrical power supply in the cabin, thanks to the use of high-life batteries.

The device according to the invention, in particular, allows retro-fitting on existing systems, in fact starting from an already existing gas distribution piping 11 or 111, by creating two holes 19 and 31 or a single hole 119, however creating two outlets, one that exploits the gas flow directly and therefore creates a sort of flow thrust with speed, a total pressure is created that is greater than the static one, and by placing a probe in the main piping 11 or 111, i.e., the first branch pipe 12 or 112, in a direction opposite to the gas flow, as a pressure pick-up, and another probe, i.e., the second branch pipe 16 or 116, oriented in the flow direction, so as to subtract from the total pressure the dynamic pressure plus a certain pressure drop generated by the shape of the probe inserted into the main piping 11 or 111, this difference in pressure between the first and second probes causes a gas flow in a branch of the main piping 11 or 111.

This branch is defined inside the measuring means 13 or 113, i.e., in a gas meter, also of a type known per se.

These measuring means 13 or 113 have smaller dimensions than the dimensions of the measuring means such that should be necessarily introduced directly into the main piping 11 or 111 to measure the flow rate of the entire gas flow, where the measuring device according to the invention is required to measure only a portion, i.e., a drainage, of the entire gas flow transiting in the main piping.

The invention thus conceived is susceptible of numerous modifications and variations, all of which are within the scope of the inventive concept; moreover, all the details may be replaced by other technically equivalent elements.

In practice, the materials used could be of any type, so long as they are compatible with the specific use, as well as the contingent shapes and dimensions, according to requirements and the state of the art.

Where the characteristics and techniques mentioned in any claim are followed by reference signs, such reference signs should be intended as having been added for the sole purpose of increasing the intelligibility of the claims and consequently such reference signs have no limiting effect on the interpretation of each element identified by way of example by such reference signs.

1. A device for the measurement of the flow rate of a gas in a main gas piping, comprising:
first branch means, which in turn comprise a first branch pipe, developing inside a main piping according to a second direction at least in part transversal to a first direction of said main piping; said first branch pipe being configured for the diversion of a portion of a gas flow in transit in the main piping towards measuring means,
the measuring means, comprising an inlet mouth, connected to the first branch pipe, and an outlet mouth, said measuring means being configured for the direct measurement of the flow rate of the portion of gas flow, diverted by the main piping, which crosses the same measuring means,
and second branch means, which in turn comprise a second branch pipe connected to the outlet mouth and configured for the re-introduction into the main piping of the diverted portion of gas flow crossing the measuring means,
said first branch pipe and said second branch pipe are being concentric, said first branch pipe, comprising an external sampling tube, developing according to a second direction orthogonal to the first direction, said sampling tube crossing the wall of said main piping at a through hole defined on the same wall,
said sampling tube having at a first end a connecting section for the connection with said measuring means,
said sampling tube having a second end, opposite to the first end, closed, and being positioned in such a way that said second end is close to or in contact with the internal surface of said wall,
said sampling tube having three lateral sampling holes, said lateral sampling holes being open, and turned, in the direction opposite to the direction of a gas flow in the main piping,
said second branch pipe comprising a return tube, developing according to a third direction orthogonal to said first direction and coinciding with said second direction,
wherein
a lateral sampling hole of the sampling tube is placed at the axis of the main piping,
said second branch pipe has a lateral return hole turned in the same direction of said gas flow, said lateral return hole developing along the same axis as the main piping,
said lateral return hole comprising a tubular section positioned between said return tube and said sampling tube, so as to create a passage between the second branch pipe and the inside of said main piping.

2. The device according to claim 1, wherein said measuring means, configured for the direct measurement of the flow rate of the portion of gas flow diverted through the first branch pipe by the main piping, comprise a box-like containment body, inside which a passage is defined through which said portion of gas flow, intercepted and diverted by the first branch pipe, passes from said inlet mouth to said outlet mouth.

3. The device according to claim 1, wherein said passage is configured in such a way as to let said portion of gas flow pass through a flow rate detector configured for the direct measurement of the transiting gas flow.

4. The device according to claim 1, wherein said flow rate detector is of the ultrasound type.

5. The device according to claim 1, wherein said measuring means comprise an electronic unit configured for the transmission of the flow rate values detected by the flow rate detector.

6. A device for the measurement of the flow rate of a gas in a main gas piping, comprising:
first branch means configured for the diversion of a portion of a gas flow in transit in a main piping towards measuring means,
measuring means, comprising an inlet mouth, connected to said first branch means, and an outlet mouth, said measuring means being configured for the direct measurement of the flow rate of the portion of gas flow, diverted from the main piping, which crosses the same measuring means,
second branch means, connected to the outlet mouth and configured for the re-introduction into the main piping of the diverted portion of gas flow crossing said measuring means.

7. The device according to claim 6, wherein said first branch means comprise a first branch pipe, configured to be positioned inside the main piping according to a second direction at least in part transversal to a first transit direction of a gas in the main piping, said first branch pipe being configured for the diversion of a portion of a gas flow in transit in the main piping towards the measuring means.

8. The device according to claim 6, wherein said second branch means comprise a second branch pipe, connected to said outlet mouth and configured for the re-introduction into said main piping of the portion of gas flow crossing the measuring means.

9. The device according to claim 8, wherein said first branch pipe comprises a sampling tube.

10. The device according to claim 9, wherein said sampling tube has at least one lateral sampling hole.

11. The device according to claim 6, wherein said measuring means, configured for the direct measurement of the flow rate of the portion of gas flow diverted through the first branch pipe by the main piping, comprise a box-like containment body, inside which a passage is defined in which the portion of gas flow, intercepted and diverted by said first branch pipe, passes from said inlet mouth to said outlet mouth.

12. The device according to claim 11, wherein said passage is configured in such a way as to let the diverted portion of gas flow passing through a flow rate detector configured for the direct measurement of the transiting gas flow.

13. The device according to claim 6, wherein said measuring means comprise an electronic unit configured to calculate the gas flow rate in the main piping starting from the values detected by measuring the flow rate of the portion of gas flow passing through the flow rate detector.
